(19) United States
(12) Patent Application Publication
(10) Pub. No.: US 2010/0025573 A1
(43) Pub. Date: Feb. 4, 2010

(54) 5 NS OR LESS NEUTRON AND GAMMA PULSE GENERATOR

(75) Inventors: Sami K. Hahto, Nashua, NH (US); Ka-Ngo Leung, Hercules, CA (US); Taneli Ville Matias Kalvas, Leppavesi (FI)

Correspondence Address: LAWRENCE BERKELEY NATIONAL LABORATORY, Technology Transfer & Intellectual Propery Managem, One Cyolotron Road MS 56A-120, BERKELEY, CA, 94720, US

(73) Assignee: The Regents of the University of California, Oakland, CA (US)

(21) Appl. No.: 12/529,689

(22) PCT Filed: Dec. 14, 2007
(86) PCT No.: PCT/US07/87560

§ 371 Date: Sep. 18, 2009

Related U.S. Application Data
(60) Provisional application No. 60/893,534, filed on Mar. 7, 2007.

(51) Int. Cl. H05H 3/06

(52) U.S. Cl. 250/251

(57) ABSTRACT

A fast nuclear particle generator is described, useful for highly penetrating particle beam inspection equipment, that is capable of generating pulses of 5 ns or less, which pulses may comprise neutrons of various energies, gammas of various energies, or a mixture of neutron and gammas of various energies. The nuclear particle generator includes means for decelerating an incident swept beam so that nuclear particles are generated only during that small time interval that a beam strikes a target. This eliminates spurious background nuclear particle generation, and decreases beam dump cooling requirements.

### CROSS REFERENCE TO RELATED APPLICATIONS

This application claims priority to Provisional U.S. Application Ser. No. 60/893,534 field Mar. 3, 2007, entitled 5 ns or less Neutron and Gamma Pulse Generator.

### STATEMENT REGARDING FEDERAL FUNDING

This invention was made with U.S. Government support under Contract Number DE-AC02-05CH11231 between the U.S. Department of Energy and The Regents of the University of California for the management and operation of the Lawrence Berkeley National Laboratory. The U.S. Government has certain rights in this invention.

### BACKGROUND OF THE INVENTION

1. Field of the Invention

The present invention generally relates to fast nuclear particle generation, more specifically fast neutron or gamma generation, and still more specifically to a method and apparatus for the generation of neutron or gamma pulses of less than 5 ns duration.

2. Description of the Relevant Art

Fast neutron pulses in the order of 5 ns long are being considered for aeroplane cargo screening to detect explosives by way of fast neutron transmission spectroscopy. In this application where cargo containers are interrogated by a short, nanosecond neutron pulse, materials within a targeted container interact with the neutron beam with characteristic neutron absorption at specific absorption energies. By this method, the energy of the neutrons passing through a sample in the cargo container can be measured, the attenuation of the neutron energies a function of the nature of the materials encountered by the neutron beam. Thus, the elemental composition of the target material can be determined: i.e. whether or not the sample presents such explosive containing elements as N, H, C, and O, especially an elevated level of N.

In this application a neutron beam having a wide spectrum of energies is particularly desirable, and is provided by the T-T reaction. Given the differences in time of flight of fast (that is higher energy) neutrons versus slower (lower energy) neutrons, it is possible to spectrographically analyze the material inside the container, the neutron absorption of the various material elements being detectable at different times. However, in the presence of a continuous, wide energy neutron beam, these absorption responses become masked. Thus, if one wished to detect the elemental materials of an explosive, short length pulses are necessary. Otherwise the neutrons from the source target interfere with detection of the neutron absorptions resulting from neutron encounters with the materials being interrogated.

Similarly, this spectrographic technique can be used for gamma ray detection with the gamma ray sensor positioned at a greater distance from the suspect material. In this application, a higher energy neutron beam (e.g. 14 MeV) is directed at the suspect target, with the generation by the elements of interest (that is N, H, C, and O) via the thermal neutron capture reaction at different energies of gamma rays. Given different gamma energies, the time of arrival of the gammas at a gamma ray detector placed some distance away will vary, the arrival times indicative of the exposed material. As with neutron attenuation, the interrogating neutron beam must be quite short, in the order of just a few nanoseconds, if the arrival times to the detector of the generated gammas are not to be masked.

Both more traditional axial RF driven plasma ion sources and the co-axial RF driven plasma sources developed at the Lawrence Berkeley National Laboratory as variously illustrated by U.S. Pat. Nos. 4,793,961; 4,447,732; 5,198,677; 5,945,677; 6,094,012; 6,907,097; and 6,975,072 (which are herein incorporated by reference) have been proposed for the generation of neutron beams for use in fast neutron analysis.

In the case of the coaxial plasma source, a T⁺ plasma is created in the toroidal plasma chamber of the coaxial source where multiple slit beams are extracted towards a target located at the center axis of the source. Fast neutron pulses are achieved by sweeping the ion beams across a collimator slit by a fast voltage sweep of the chopper electrodes. This creates a T⁺ current pulse of 5 ns in length, which then produces the neutron pulse upon hitting the tritium and/or deuterium containing titanium target.

One problem with the above approach is that the alignment of the multiple slit extraction geometry is difficult. Additionally, the large plasma chamber volume leads to a very large RF input power requirement, and most of the time the ion beam is dumped onto the collimator electrode at an intermediate energy (30 keV), which forms a constant, unwanted DC neutron background. Lastly, the sweeper electrode has a large surface area due to the multiple beam structure, which leads to a high input capacitance and thus longer voltage rise times for the fast voltage switches sweeping the chopper electrodes and ultimately longer neutron pulse lengths.

In an axial system a similar approach has been proposed whereby the ion beam is swept across a collimator aperture using an Einzel electrode arrangement, as described in the paper Fast Ion Beam Chopping System for Neutron Generators, S. K. Hato, et al, Review of Scientific Instruments 76, pages 023304-1 to 12204-5. As with the coaxial plasma source, most of the time the ion beam is dumped into the collimator electrode which likewise leads to the generation of a constant and unwanted dc neutron background.

### BRIEF SUMMARY OF THE INVENTION

By way of this invention, a fast neutron beam source is provided which suffers from none of the aforementioned problems. In one embodiment, this invention provides an apparatus comprising a plasma ion source, an extraction electrode, a focusing Einzel lens comprising a split electrode, means for regulating the voltage difference between the halves of the split electrode, an acceleration column positioned downstream of the Einzel lens and a small target positioned downstream of the acceleration column and in the path of the ion beam.

In another embodiment of the invention a method for generating a nanosecond neutron pulse is described comprising the steps of: a) providing a plasma source; b) forming a beam by extracting the plasma from the plasma source; c) generating a neutron pulse by alternately sweeping the beam across a target; and d) decelerating the beam that has not struck the target to minimize: i) heating of a beam dump; and ii) generating spurious neutrons not generated from the target.

The sweeping step can produce neutron pulses of less than or equal to 5 ns full width half maximum (FWHM). By increasing sweep rates, pulses of even shorter duration such as for 2 ns, 1 ns, or even less can be realized.

The target in the system may have a surface exposed to the beam that is substantially comprised of titanium. Such neutron generating targets are typically pre-implanted with deuterium ions or tritium ions, or can be implanted by the D or T ions of the plasma itself in the course of operation.

The plasma source may be a multicusp plasma source, where the plasma source may be selected from one or more of the group consisting of: hydrogen, deuterium, and tritium.

The nuclear particle pulse may comprise: a) neutrons with one or more energies, b) gammas with one or more energies, or c) a combination of neutrons with one or more energies and gammas with one or more energies.

### BRIEF DESCRIPTION OF THE SEVERAL VIEWS OF THE DRAWINGS

The invention will be more fully understood by reference to the following drawings, which are for illustrative purposes only:

FIG. 1 is a schematic of one embodiment of the invention, where the tritium beam is directed to the target via a split element voltage of 0 V, thereby producing neutron fusion products.

FIG. 2 is a schematic of one embodiment of the invention, where the tritium beam is directed off the target via a ±4 kV split electrode, thereby not producing neutron fusion products when off-target.

### DETAILED DESCRIPTION OF THE PREFERRED EMBODIMENT

To overcome the problems of existing short duration neutron pulse sources, a new source and extraction geometry has been developed. Instead of a toroidal source and radial extraction, an axial geometry is used. And instead of an axial geometry where the beam is scanned across an aperture of a collimator beam dump before impacting the source target, the target is placed before the beam dump, which is maintained at a positive potential relative to the beam to slow the beam down.

The plasma is formed with an axial RF source and extracted through a single slit. The 5 ns neutron pulses are formed by sweeping the beam across the titanium target directly without using a collimating electrode. The beam that passes the target between the neutron pulses is slowed down to a low energy (1 keV) and dumped onto a beam dump. This single beam and collimator-free approach minimizes alignment problems associated with the co-axial source, and drastically reduces the beam power delivered to the beam dump, thus almost completely removing the dc neutron background of the prior approaches.

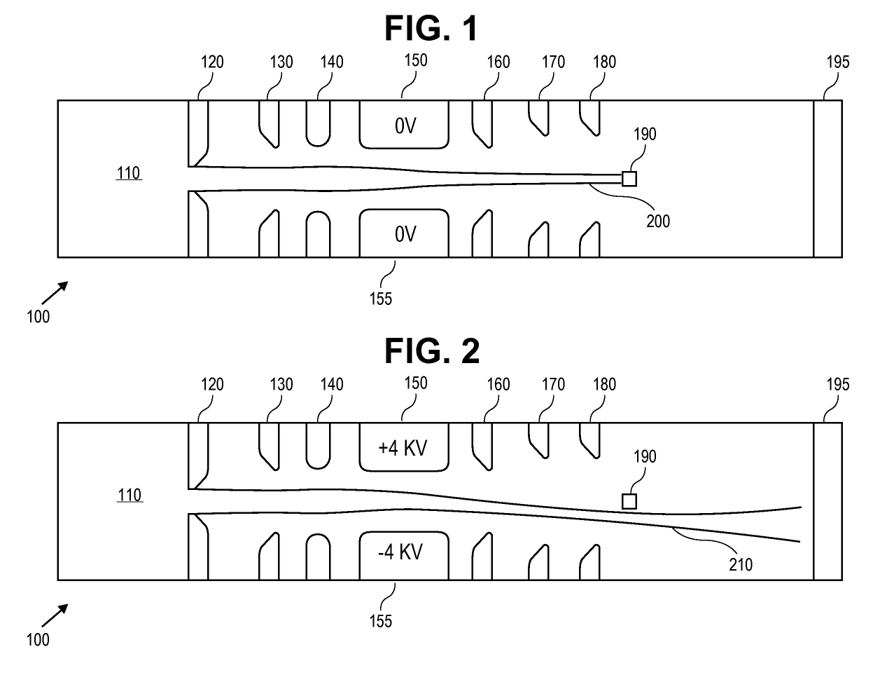

Referring now to FIG. 1, a diagram of the apparatus of this invention, a high speed pulsed neutron generator 100 is illustrated. A traditional axial extraction tritium ion source (T⁺) 110 is used to generate a tritium plasma. In one embodiment the ion source can be a quartz cylinder with an external water cooled radio frequency (rf) antenna coiled around it. Source ions are extracted through an aperture of the plasma electrode 120, and accelerated through the first of two extraction lens elements 130, and 140. In the experiment later described, lens element 130 is maintained at −55 kV, and lens element 140 maintained at −12.5 kV. The Einzel lens is a split electrode, containing elements 150 and 155. These elements are electrically isolated one from the other such that differential voltages may be applied to the upper element 150 and lower element 155. Following the Einzel lens, the ions are accelerated to their final energy before striking source target 190 by acceleration column elements 160, 170, and 180. By sectioning of the acceleration column, the field gradient on the insulators can be reduced, thus enabling higher voltages. In the experiment, acceleration element 160 was maintained at −130 kV, element 170 maintained at −180 kV, and element 180 maintained at −200 kV.

The beam 200, focused through the Einzel lens, with the upper 150 and lower 155 elements at essentially a zero differential voltage, remains undeflected, directly striking the target 190, which target is maintained at the same potential as of the last of the acceleration lenses. The remainder of the hardware comprises a beam dump 195, which is discussed below.

Referring now to FIG. 2, the upper split electrode 150 is maintained relative to the lower electrode at +Δ kV (about +4 kV in the example), while the lower electrode 155 is maintained relative to the upper at −Δ kV (about −4 kV in the example). This differential in electrode voltages causes the T⁺ ion beam to deflect downwardly, thus missing target 190, to instead strike the beam dump 195, which is maintained at a much lower voltage. The beam dump is sized such that any portion of the swept beam not falling on the target will fall on the beam dump. Since the beam dump is maintained at a more positive potential relative to the acceleration of the deflected beam 210, the beam 210 is substantially decelerated.

In the experimental example, the beam dump is maintained at −4 kV, the ion beam thus impacting the beam dump only at 4/200^{ths} of its peak energy, rather than at its fully accelerated energy of 200 keV. As a result, beam dump 195 requires substantially less cooling. Additionally, and most importantly, since the T⁺ ions are striking the beam dump 195 with only 4 keV energy, the beam energy is insufficient to cause T-T fusion reactions at the beam dump. Hence, there is no neutron generation at the beam dump 195.

Similarly, the upper 150 and lower 155 split electrodes may be reverse biased from −Δ kV to +Δ kV, thereby causing the beam trajectory 210 in FIG. 2 to reverse, and instead arrive above the target 190 on the beam dump 195.

By alternately sweeping the voltages of the upper 150 and lower 155 split electrodes, the T⁺ ion beam may be repeatedly swept from positions above and below the target 190. Since the alternate sweep voltage Δ kV, or ±4 kV in the example, is relatively low, it is possible to sweep the beam sufficiently fast so that the beam in on target but for a few nanoseconds, to produce neutron pulses of durations between 2-5 ns.

### Experiment

In an experiment according to the invention, a tritium plasma source was generated in an RF discharge. The ion source was a 10 cm diameter quartz cylinder, with an rf coil around it. The source plasma was formed with a 2.45 MHz rf generator with an accompanying inductive matching network. The extraction slit was 1 cm×7 cm, and the total extracted T+ current was 250 mA. The beam was extracted with the first extraction electrode at −55 KV, the second extraction electrode maintained at −12.5 kV, and the beam is focused with the Einzel lens. The Einzel lens was maintained at between −76 kV and −84 kV. To vary the voltages to each of the halves of the split lens, two DEI PVX-4140 pulse generators with accompanying high voltage power supplies were connected to the two halves of the lens. The pulse generators were connected in a push-pull setup, where the voltages of the split electrodes could be swept from −76V to −84V and from −84V to −76V respectively. The focused beam was accelerated through a 3 stage acceleration column to a 5 mm diameter target maintained at −200 keV. The two halves of the split Einzel electrode are maintained at 80 kV in the un-swept state, and a voltage difference of ±4 kV maintained, sweeping the voltage with a fast HV switch. As the voltage difference between the halves approached zero, and continued sweeping to reverse polarity the beam is swept across the 5 mm diameter target maintained at −200 kV, and a fast beam neutron pulse generated. The sweep according to this experiment resulted in a beam pulse of about 5 nanoseconds.

The description given here, and best modes of operation of the invention, are not intended to limit the scope of the invention. Many modifications, alternative constructions, and equivalents may be employed without departing from the scope and spirit of the invention.

We claim:

1. A method of generating a nanosecond neutron pulse comprising the steps of:
a) providing a plasma source;
b) forming an ion beam by extracting plasma from the plasma source; and,
c) generating a neutron pulse by alternately sweeping the generated beam across a target.

2. The method of claim 1 wherein the swept beam is first accelerated prior to striking the target.

3. The method of claim 2 wherein that portion of the accelerated beam that does not strike the target is decelerated.

4. The method of claim 3 wherein the decelerating step is achieved by providing a beam dump which is maintained at a higher potential voltage than that of the generated beam.

5. The method of claim 4 wherein the beam is decelerated to minimize the heating of the beam dump, and the generating spurious neutrons not generated from the target

6. The method of claim 1, wherein the target has a surface exposed to the beam that is substantially comprised of titanium.

7. The method of claim 1, wherein the sweeping step produces a neutron pulse for less than or equal to 5 ns.

8. The method of claim 1 wherein the sweeping step produces the neutron pulse for less than or equal to 2 ns.

9. The method of claim 1 wherein the sweeping step produces the neutron pulse for less than or equal to 1 ns.

10. The method of claim 1, wherein the plasma source is selected from one or more of the group consisting of:
a) hydrogen;
b) deuterium; and,
c) tritium.

11. A method of nanosecond nuclear particle pulse generation comprising the steps of:
a) providing a plasma source;
b) forming a beam by extracting plasma from the plasma source;
c) generating a nuclear particle pulse by alternately sweeping the beam across a target; and
d) decelerating the beam that has not struck the target to minimize:
i) heating of a beam dump; and
ii) generating spurious nuclear particles not generated from the target.

12. The method of nanosecond nuclear particle pulse generation of claim 11 wherein the nuclear particle pulse comprises:
a) neutrons with one or more energies,
b) gammas with one or more energies, or
c) a combination of neutrons with one or more energies and gammas with one or more energies.

13. The method of nanosecond nuclear particle pulse generation of claim 11, wherein the sweeping step produces the nuclear particle pulse for less than or equal to 5 ns.

14. The method of nanosecond nuclear particle pulse generation of claim 11, wherein the sweeping step produces the nuclear particle pulse for less than or equal to 2 ns.

15. The method of nanosecond nuclear particle pulse generation of claim 11, wherein the sweeping step produces the nuclear particle pulse for less than or equal to 1 ns.

16. A nanosecond nuclear particle pulse generator, comprising:
a) a plasma source that provides a source for a plasma beam;
b) a nanosecond nuclear particle pulse generator means; and
c) a plasma beam decelerator means,
whereby the beam is swept across a target to produce one or more nuclear particles, and when not striking the target is decelerated by the decelerator means so as to not produce nuclear particles.

17. An apparatus for generating pulsed neutron particle beams comprising:
a) a plasma source
b) an extraction electrode for extracting an ion beam from said plasma source.
c) an Einzel lens, wherein the Einzel lens electrode is split into two halves;
d) a high voltage power source connected to each of the two halves of the Einzel electrode, said power source capable of sweeping the voltages from −Δ kV to +Δ kV and from +Δ kV to −Δ kV;
e) an acceleration column comprising at least one electrode for accelerating the extracted ion beam to the final beam energy;
f) a neutron source target positioned downstream of the acceleration column; and,
g) a beam dump positioned behind the neutron source target, said beam dump sized to intercept any portion of the ion beam not falling on the target.

18. The apparatus of claim 17 wherein the plasma source is a multicusp plasma source.

19. The apparatus of claim 17 wherein the acceleration column includes more than one accelerating electrode.

20. The apparatus of claim 19 wherein the acceleration column comprises three accelerating electrodes.

21. The apparatus of claim 17 wherein the beam dump is maintained at a positive voltage potential relative to the beam potential of the final electrode of the acceleration column.

22. The apparatus of claim 17 wherein ±Δ kV is ±4 kV.
